(19) United States
(12) Patent Application Publication
(10) Pub. No.: US 2004/0129764 A1
(43) Pub. Date: Jul. 8, 2004

(54) Reducing surface tension and oxidation potential of tin-based solders

(76) Inventor: Chun Christine Dong, Macungie, PA (US)

Correspondence Address: AIR PRODUCTS AND CHEMICALS, INC., PATENT DEPARTMENT, 7201 HAMILTON BOULEVARD, ALLENTOWN, PA, 181951501

(21) Appl. No.: 10/337,700

(22) Filed: Jan. 7, 2003

(51) Int. Cl. B23K 35/12; B23K 31/02

(52) U.S. Cl. 228/245; 228/256

(57) ABSTRACT

A tin-based solder material and method comprising same are disclosed herein. In one embodiment, the solder material comprises 0.00001 to 10 weight percent of at least one of the following elements: selenium, tellurium, arsenic, polonium, or thallium. After heating to one or more temperatures in a non-oxidizing atmosphere sufficient to melt the solder, the at least one element substantially segregates to the surface of the molten solder composition. The at least one element improves the solder joint formed between at least two substrates by reducing the surface tension of the molten solder.

### BACKGROUND OF THE INVENTION

The present invention relates generally to soldering processes. More specifically, the invention relates to solder compositions and methods comprising same that reduce the surface tension and oxidation potential of a tin-based solder composition.

Soldering is an important processing step in the assembly of electronic products. For example, a soldered printed circuit board may have hundreds of solder joints that are used to connect capacitors, resistors, transistors, and ICs to the board. It becomes increasingly important to ensure a correct interaction between these components and the board. To achieve this, the solder joints between the components and the board should provide negligible contact resistance and an acceptable mechanical strength.

The term “soldering” generally refer to a process that uses a filler material such as a low melting point metal alloy or solder material to join at least two metallic substrates without melting the base material. As a material joining technique, soldering is quite different to welding. During a welding process, the base metals to be joined are melted and a metallurgical bond is formed by the diffusion of the molten base metals with or without a molten filler material. During a soldering process, however, only the filler or solder material-rather than base material- becomes molten.

The formation of the interface between the base material and the molten solder generally depends on the physical wetting of the solder to the base material. The larger the degree of physical wetting of the solder to the base material, the stronger the metallic bond that is formed between the base material and solder. Thus, a good wetting of a solder on the surface of component leads and the corresponding solder lands of a printed circuit board may be key to obtaining a reliable solder joint. By contrast, a poor wetting may cause soldering defects such as open joints and bridging. The degree of wetting of the molten solder on the surface of the substrate can be evaluated by the contact angle between the solder and the substrates. The contact angle, θ, may be determined by Young's equation:

$$cos θ = \frac{{γ}_{sv} - {γ}_{sl}}{{γ}_{lv}}$$

where γₗᵥ is the surface tension of the liquid solder, γₛᵥ is the surface tension of the solid substrate, and γₛₗ is the interfacial tension between the liquid solder and the solid substrate. Good wetting, i.e., a small θ, is linked to small values of γₗᵥ and γₛₗ in combination with a relatively large value of γₛᵥ.

A thin oxide layer on the liquid solder and substrate is detrimental to the wetting of the substrate because it reduces the surface tension of the substrate and also prevents intimate contact between the solder and substrate. Oxide layers tend to exist in the majority of industrial metal surface and must therefore be broken down and removed prior to soldering. The strategy to remove initial oxide layers and prevent oxidation of the solder joint differs depending upon the method of soldering. In wave soldering, the oxidation of the molten solder forms an impurity known as dross, which needs to be frequently removed. In addition, an organic flux may be used to pre-clean the surface of the base metal. In reflow soldering, an organic flux may be added to the solder paste to removes oxides on both the solder and base metal surfaces and keep the surfaces in a clean state during reflow. Another role of the flux in a reflow soldering process is to reduce the surface tension of the liquid solder thereby promoting solder wetting.

There are some problems associated with the use of organic fluxes. Flux volatiles, which result from the decomposition of organic fluxes, may form voids in the solder joints. Further, flux residues on the circuit board that may cause corrosion and electric shorts. To remedy these problems, chlorofluorcarbons (CFCs) are used as cleaning agents to remove the flux residues. However, post-cleaning adds an additional process step and increases manufacturing processing time. Further, the use of chlorofluorocarbons (CFCs) as cleaning agents is banned due to the potential damage to the earth's protective ozone layer.

In the past several years, the soldering technology of the electronic assembly industry has undergone several changes. The industry has transitioned from lead-containing solders such as tin-lead solders to lead-free solders due to environmental and health concerns about lead contamination. The use of lead-free solders, along with the increasing need to adopt a fluxless soldering technique has presented new challenges to the electronic assembly industry. One of the main challenges in adopting a lead-free solder and/or a fluxless soldering method is the decreased wettability of the solder on the substrate surface. The surface tension of the majority of lead-free solders is significantly higher than that of the eutectic tin-lead solder thereby reducing the wettability of the lead-free solder. The absence of a low surface tension flux covering coupled with the use of lead-free soldering have further increased the surface tension of the molten solder leading to poor wetting of the substrate surface. In addition, most lead-free solders have higher melting temperatures than that of the eutectic tin-lead solder; thus the oxidation potential of the molten lead-free solders may be generally high. The increased oxidation potential of the solder promotes dross formation during wave soldering may increase the consumption of solder. Even when nitrogen or other inert atmospheres are used, oxygen contamination may still occur due to air leakage within the soldering machine.

The prior art provides some methods that are used to address some of these problems by introducing trace elements to a solder composition. However, the objectives, applications, method, or processing conditions may not be ideal for effectively addressing all of these problems. For example, U.S. Pat. Nos. 4,121,750 and 4,241,148 discuss reducing the viscosity and surface tension of the molten solder, as well as the interfacial tension between the molten solder and the substrate, by adding 0.1 to 10 weight percent of at least one of the following metals, Ba, Bi, Sb, and Sr, into an aluminum-based or zinc-based solder. These solders are useful for soldering aluminum-containing work pieces.

U.S. Pat. No. 5,390,845 describes adding 0.0001 to 1 weight percent of at least one of the following materials, P, Ca, Ag, Bi, Cu, Au, Hg, Ba, Li, Na, Te, K, Rb, Cs, Al, Sb, Zn, or Cd, into a tin-lead solder for wave soldering or reflow soldering in a diluent gas (e.g., N₂, Ar, He, H₂) that may contain up to 10% by volume of oxygen. The '845 patent teaches that the addition of these materials may reduce bridging by reducing the surface tension of the molten solder. However, most of the materials provided in the '845 patent have higher oxidation potentials than that of tin so that the addition of these materials may increase the oxidation tendency of the solder which is undesirable. Another material cited in the '845 patent, phosphorous, has a very low surface tension and oxidation potential relative to tin but is extremely volatile and can not be easily maintained on the surface of the molten solder thereby decreasing its effectiveness as surface tension reducing agent for the solder.

Japanese Patent Application JP 1998-180481 discloses improving the oxidation-resistance of a tin-based or Sn-Ag based lead-free solder by adding 0.01 to 0.1 weight percent of Ge in combination with additional elements such as Te, Ga, Ag, S, and/or Sb. While all of these elements have an oxidation-suppressive effect, some of these elements, such as Ge, Ga, and Ag, have a higher surface tension than that of tin thereby preventing these elements from effectively reducing the surface tension of the solder so that the effect of additing these trace elements to suppress oxidation is limited.

Accordingly, there is a need in the art to provide a method that can influence the equilibrium of the surface and interfacial tensions at the solder joint area by reducing the contact angle to improve wetting of the substrate surface with the lead-free and fluxless solders. There is a further need in the art to minimize surface oxidation during soldering. A reduction in the surface tension and oxidation potential of the molten solder may reduce a variety of manufacturing defects such as open joints, bridging, or the like. To follow the industrial tend in electronic assembly, a development of such a method becomes increasingly important.

All references cited herein are incorporated herein by reference in their entirety.

### BRIEF SUMMARY OF THE INVENTION

The present invention is directed, in part, to soldering compositions and methods comprising same. Specifically, in one aspect of the present invention, there is provided a method for forming a solder joint between at least two substrates comprising: treating the surface of at least one substrate with a solder material comprising 0.00001 to 10 weight percent of at least one element from the group consisting of selenium, tellurium, arsenic, polonium, thallium, or combinations thereof to form a treated area; disposing the at least two substrates at or within close proximity to at least a portion of the treated area; and heating the at least two substrates in a non-oxidizing atmosphere to at least one temperature sufficient to melt the solder material within the treated area.

In a further aspect of the present invention, there is provided a method of improving the surface tension between a treated area and at least one substrate, the method comprising: adding 0.00001 to 10 weight percent of at least one element from the group consisting of selenium, tellurium, arsenic, polonium, thallium, or combinations thereof to a tin-based solder material; treating the surface of at least one substrate with the solder material to form a treated area; and heating the treated area in a non-oxidizing atmosphere to at least one temperature sufficient to melt the solder material within the treated area wherein the at least one element segregates to substantially the surface of the molten solder.

In yet another aspect of the present invention, there is provided a solder composition comprising from 2 to 99.9% weight percent of tin and from 0.00001 to 10% weight percent of at least one element from the group consisting of selenium, tellurium, polonium, thallium, or combinations thereof.

These and other aspects of the invention will become apparent from the following detailed description.

### BRIEF DESCRIPTION OF SEVERAL VIEWS OF THE DRAWINGS

FIG. 1a provides a cross-sectional view of the solder composition of the present invention.

FIG. 1b provides a cross-sectional view of the solder composition of a comparable solder composition.

### DETAILED DESCRIPTION OF THE INVENTION

The present invention is directed to a solder composition and a method comprising same that improves the solder joint formed by reducing the surface tension and oxidation potential of the molten solder, particularly tin-based lead-free solders. In this manner, the solder material, when heated to a temperature at or above its melting temperature, may better wet the surface of the underlying substrate by enhancing the spreading of the molten solder. To accomplish this, the present invention adds one or more of the following elements, selenium, tellurium, arsenic, polonium, thallium or combinations thereof, in a trace amount, from 0.00001 to 10 weight percent, to the solder composition, preferably a lead-free tin-based solder composition. The soldering process is conducted in a nonoxidizing atmosphere having an oxygen and/or moisture concentration of 1,000 ppm or below, preferably 200 ppm or below, or more preferably 100 ppm or below. Further, the solder composition and method comprising same reduces the surface tension and oxidation potential of the molten solder thereby minimizing the need for an organic flux.

The solder composition and method comprising same is suitable for a variety of different soldering processes including, but not limited to, solder coating, dip soldering, hand soldering, wave soldering, or reflow soldering. In certain preferred embodiments, the soldering process used in the method of the present invention is a fluxless soldering process. The addition of at least one element does not increase the potential of forming an initial oxide at ambient conditions. The thickness and the composition of the initial surface oxide formed on the solder is approximately the same as that of an unmodified solder, i.e., a solder composition without the addition of the elements provided in the present invention. Thus, the addition of the at least one element to the solder composition should not increase the difficulty of removing the initial surface oxide by fluxless soldering.

In embodiments wherein the fluxless soldering is conducted in a reducing gas environment, the at least one element may spontaneously segregate to the top surface of the molten solder to reduce the surface tension of the solder thereby promoting solder wetting. In embodiments wherein the soldering process is a wave soldering process in an oxygen-containing inert environment, the addition of the at least one element may also segregate to the surface of the molten solder. This surface segregation, wherein the least one element resides at or substantially near (i.e., or within the first few nanometers) the surface of the molten solder reduces the surface tension of the molten solder and also effectively suppresses surface oxidation. Thus, dross formation can be largely reduced.

While not being bound by theory, it is believed that the elements disclosed herein are more effective than other elements disclosed in the art in reducing surface tension and oxidation potential at soldering process conditions because the elements of the present invention meet the following criteria which is provided in Table I. First, the elements of the present invention each have a significantly lower surface tension than that of tin. Second, the elements of the present invention each have a significantly lower oxide formation energy, or a less negative value, than that of tin. Third, the elements may have a suitable melting point, e.g., have a melting point at or around the soldering temperature, or may demonstrate a sufficient solubility in tin, e.g., greater than 1% of the element is soluble at the soldering temperature. However, the at least one element may not necessarily solublize and can exist as a discreet phase within the solder composition. Lastly, the elements each have a suitable vapor pressure, or are not too volatile as reflected by each element's lower temperature at a pressure of 1 torr relative to that of tin. Therefore, in an inert or reducing soldering environment, the elements may spontaneously segregate to the surface of the molten solder to reduce the surface tension. This surface segregation may also effectively reduce the oxidation potential of the solder in presence of air leakage.

TABLE I

| | | | | Oxide |
|---|---|---|---|---|
| | | | | Formation |
| | | | | Energy at |
| | | Surface | Temperature | Room |
| | Melting Point | Tension M.P. | for 1 torr | Temperature |
| Element | (“M.P.”) (° C.) | (dyne/cm) | (° C.) | (kcal/gmole) |
| Se | 221 | 160 | 356 | −28 |
| Te | 449.5 | 186 | 520 | −32.3 |
| As | 613 | 230 | 372 | −36.92 |
| Po | 254 | 250 | >300 | −23.2 |
| Tl | 303.5 | 465 | 825 | −20.5 |
| Sn | 232 | 537 | 1492 | −61 |

The solder compositions of the present invention may be tin-lead solders or contain from 2 weight percent to 63 weight percent tin and from 37 to 98 weight percent lead. These solder compositions may further contain one or more of the following metals: cadmium, silver, antimony, zinc, or indium. In embodiments wherein the solder composition comprises antimony, the amount of antimony in the composition may range from 0.25 weight percent to 4 weight percent.

In certain preferred embodiments of the present invention, the solder compositions of the present invention are preferably tin-based and lead-free solders. The melting temperatures for tin-based and lead-free solders may range from 100° C. to 395° C. In these embodiments, the solder contains from 2% to 99.9% weight percent tin or more preferably from 40% to 99.9% weight percent tin. These solder compositions may further contain one or more of the following metals: cadmium, silver, antimony, zinc, copper, bismuth, indium, or combinations thereof. These other metals may be present within the composition in an amount ranging from 0.1 to 98 weight percent, preferably from 0.1 to 20, and more preferably from 0.01 to 10 weight percent of other metals. For example, in one embodiment, the solder composition may comprise 96 weight percent tin, 4 weight percent silver and approximately 0.1 percent of at least one element such as selenium.

The amount of the at least one element that is added to the solder composition ranges from about 0.00001 to about 10 weight percent, preferably from about 0.01 to about 1 weight percent, and most preferably from about 0.1 to about 1 weight percent. In certain preferred embodiments, the at least one element of the present invention is added directly to the solder composition prior to heating to the melting or working temperature of the solder composition. Alternatively, the at least one element may also be added, for example, to the solder in the solder pot or applied directly to the substrate surface.

In the method of the present invention, the solder composition, having at least one element added to it in trace amounts or coating the surface, is used to join at least two substrates. The solder composition may be applied to at least one of the two substrates to provide a treated area. Prior to joinder, the substrate(s) may be cleaned to remove oxide films, oil, grease, or dirt via chemical or mechanical means and are rinsed and dried. The at least two substrates are positioned with respect to each other at or within close proximity to at least a portion of the treated area. The gap between the at least two substrates, if present, can be relatively small and may range from 0 to a few hundred micrometers. The assembly is subsequently heated to the soldering temperature or, at least one temperature up to 50° C. above the melting point of the solder composition, until the solder composition at the treated area has melted and spread through the gap or across the surface of at least one of the two substrates. The heating may be localized to the area to be joined or the entire assembly may be heated. The temperature or temperatures at which the solder composition melts are typically below about 450° C. and vary depending upon the composition of the solder material. The heating step is conducted in a non-oxidizing atmosphere such as a reducing or inert atmosphere.

The solder material of the present invention improves wetting by lowering the contact angle of the solder material onto the base substrate thereby increasing the surface area of solder coverage on the base substrate. Upon melting, the at least one element within the solder composition segregates substantially to the surface of the solder.

The invention will be illustrated in more detail with reference to the following examples, but it should be understood that the present invention is not deemed to be limited thereto.

### EXAMPLES

Two samples of solder material, one material with and one material without the addition of approximately 1 weight percent selenium powder, were prepared using a 2 gram piece of eutectic Sn/Ag solder pre-form manufactured by Arconium of Providence, R.I. were melted within a glass beaker in a N₂ purged glove box. A flux was used during the melting process to remove initial oxides. After melting, the samples was cooled down to room temperature.

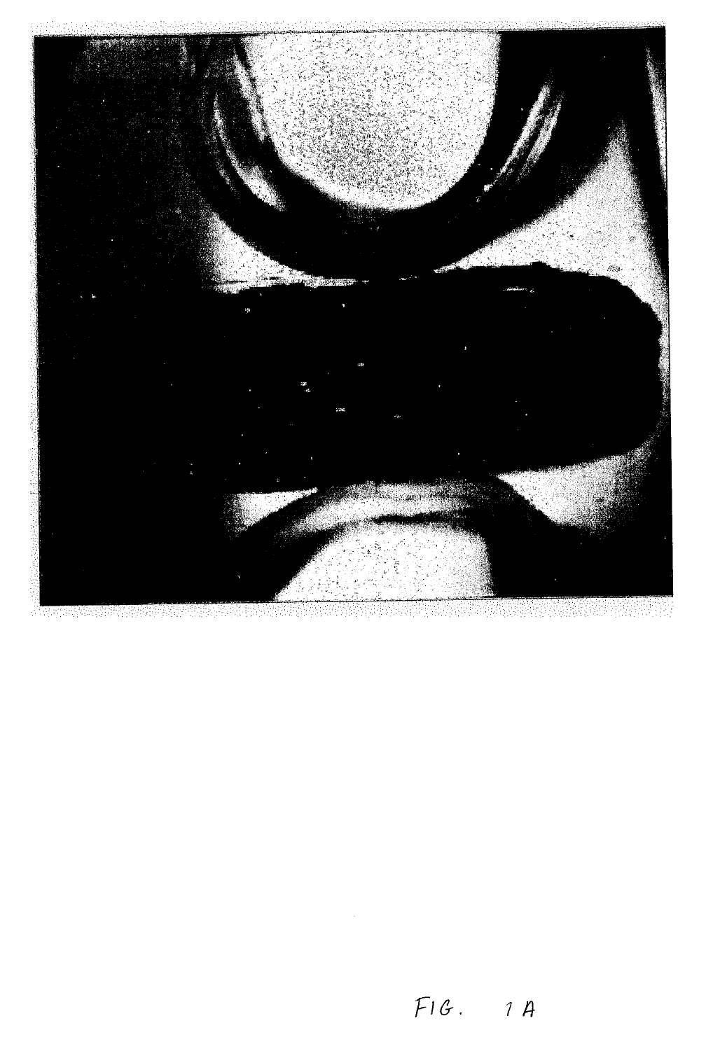

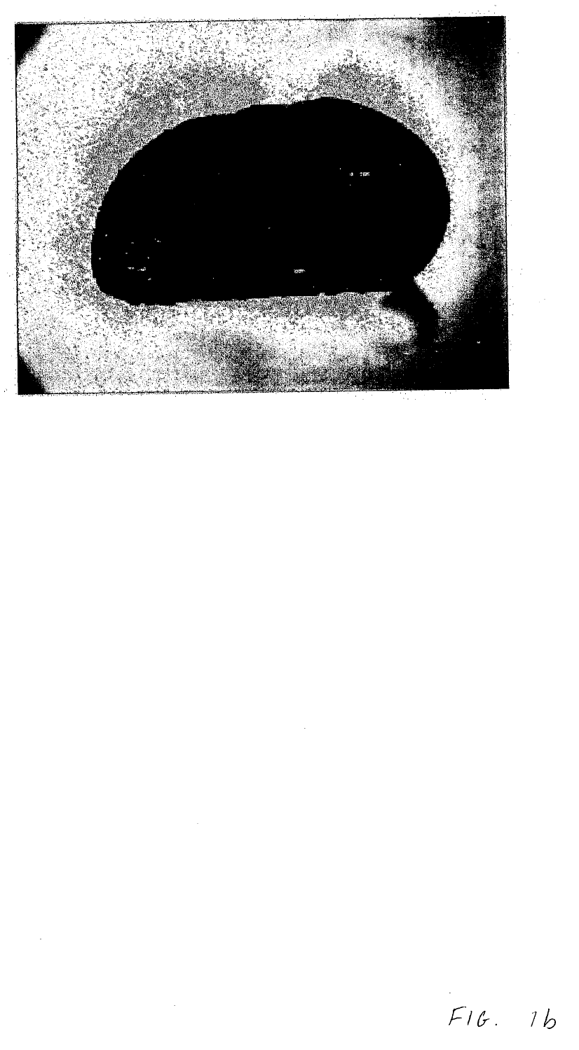

The solder samples were visually inspected and cross-sectioned vertical to the coated surface bifurcating the solder and the glass. It was found that the surface of the solder sample that included the selenium powder addition was much darker in color than that of the sample without selenium. This may indicate that weight percent of selenium addition is preferentially segregated at the surface of the sample in comparison to the sample without the selenium addition. Further, the solder sample that included the selenium addition was flatter in shape of the cross-section as compared to the sample without the selenium addition. FIGS. 1a and 1b provide a cross-sectional view of the solder samples with and without the selenium addition, respectively. As FIG. 1a illustrates, the contact angle, which is is the angle formed between the substrate surface and the tangent of the solder material surface, is approximately 37° C. The contact angle in FIG. 1a is approximately 60° C. This indicates that the solder composition with the selenium addition has a lower contact angle due to the reduction of the surface tension of the molten solder.

While the invention has been described in detail and with reference to specific examples thereof, it will be apparent to one skilled in the art that various changes and modifications can be made therein without departing from the spirit and scope thereof.

We claim:

1. A method for forming a solder joint between at least two substrates, the method comprising:
treating the surface of at least one substrate with a solder material comprising 0.00001 to 10 weight percent of at least one element from the group consisting of selenium, tellurium, arsenic, polonium, thallium, or combinations thereof to form a treated area;
disposing the at least two substrates at or within close proximity to at least a portion of the treated area; and
heating the at least two substrates in a non-oxidizing atmosphere to at least one temperature sufficient to melt the solder material within the treated area.

2. The method of claim 1 wherein the at least one element segregates to substantially the surface of the molten solder material.

3. The method of claim 1 wherein the at least one element is selenium.

4. The method of claim 1 wherein the solder material comprises tin.

5. The method of claim 4 wherein the solder material further comprises at least one metal from the group consisting of lead, cadmium, silver, antimony, zinc, indium, copper, bismuth, or combinations thereof.

6. The method of claim 1 wherein the solder material contains from 0.01 to 1 weight percent of the at least one element.

7. The method of claim 1 wherein the non-oxidizing atmosphere comprises an inert atmosphere.

8. The method of claim 1 wherein the non-oxidizing atmosphere comprises a reducing atmosphere.

9. The method of claim 1 wherein the treated area is substantially free of an organic flux.

10. A method of improving the surface tension between a treated area and at least one substrate, the method comprising:
adding 0.00001 to 10 weight percent of at least one element from the group consisting of selenium, tellurium, arsenic, polonium, thallium, or combinations thereof to a tin-based solder material;
treating the surface of at least one substrate with the solder material to form a treated area; and
heating the treated area in a non-oxidizing atmosphere to at least one temperature sufficient to melt the solder material within the treated area wherein the at least one element segregates to substantially the surface of the molten solder.

11. The method of claim 10 wherein the contact angle formed between the surface of the molten solder and the at least one substrate is about 45° C. or less.

12. The method of claim 10 wherein the solder material contains from 0.01 to 1 weight percent of the at least one element.

13. The method of claim 10 wherein the at least one element is selenium.

14. The method of claim 10 wherein the tin-based solder material comprises at least one from the group consisting of lead, cadmium, silver, antimony, zinc, indium, copper, bismuth, or combinations thereof.

15. The method of claim 10 wherein the non-oxidizing atmosphere comprises an inert atmosphere.

16. The method of claim 10 wherein the non-oxidizing atmosphere comprises a reducing atmosphere.

17. The method of claim 10 wherein the treated area is substantially free of an organic flux.

18. A solder composition comprising from 2 to 99.9% weight percent of tin and from 0.00001 to 10% weight percent of at least one element from the group consisting of selenium, tellurium, polonium, thallium, or combinations thereof.

19. The solder composition of claim 18 further comprising from 0.1 to 98 weight percent of at least one metal from the group consisting of lead, cadmium, silver, antimony, zinc, indium, copper, bismuth, or combinations thereof.

20. The solder composition of claim 18 further comprising from 0.1 to 10 weight percent of at least one metal.

21. The solder composition of claim 18 comprising from 0.1 to 1 weight percent of at least one element.
